(19) United States
(12) Patent Application Publication
(10) Pub. No.: US 2005/0196487 A1
(43) Pub. Date: Sep. 8, 2005

(54) Gum base composition

(76) Inventors: Jérôme Barra, Neydens (FR); Anh Le, Geneva (CH); Serge Noizat, Bernex (CH)

Correspondence Address: ALLAN FANUCCI;Winston and Strawn, 200 Park Ave, New York, NY, 10166, US

(21) Appl. No.: 11/109,887

(22) Filed: Apr. 19, 2005

Related U.S. Application Data
(63) Continuation of application No. PCT/IB03/05027, filed on Nov. 3, 2003.

(30) Foreign Application Priority Data
Nov. 6, 2002 (WO) PCT/IB02/04721

(51) Int. Cl. A23G 3/30

(52) U.S. Cl. 426/5

(57) ABSTRACT

The present invention relates to a gum base composition for the preparation of a chewing gum. The gum base composition includes a gum material, a silicate derivative and a polyol and is in the form of a fine and homogeneous powder which is therefore directly compressible. A process for the preparation of such a powder is also disclosed.

### CROSS-REFERENCE TO RELATED APPLICATIONS

This application is a continuation of International application PCT/IB2003/005027 filed 3 Nov. 2003, the entire content of which is expressly incorporated herein by reference thereto.

### TECHNICAL FIELD

The present invention relates to the chewing gum industry. More particularly, it concerns an improved gum base composition in the form of a directly compressible powder, advantageously used as a starting product for the preparation of a chewing gum.

### BACKGROUND ART

Processes for the preparation of chewing gums are widely described in the literature. Gum base compositions constitute the essential starting ingredient for the preparation of chewing gums. What is meant by “gum base composition” also referred to as “gum base raw material” in the prior art is usually a hard, elastic material, prepared from a mixture of various ingredients such as, in particular, natural or synthetic rubbers, waxes, emulsifiers and plasticizers. Processes for the preparation of such gum base compositions have been widely described in the literature, in particular in patents or patent applications. In a general manner, the ingredients used for the preparation of such gum base compositions are mixed at high temperatures with solvents, plasticizers and/or lubricants and are further extruded or laminated. The product thus obtained, is a hard material, physically elastic, but which cannot be handled as such.

Consequently, in a typical process for the preparation of a chewing gum, a gum base material such as here-above described is firstly melted at temperatures ranging from about 60° C. to about 120° C. for a period of time sufficient to render the base molten and viscous. Then, additional ingredients useful for the preparation of a chewing gum namely, a plasticizer, a softener, sweeteners, and/or fillers, humectants, colouring agents and flavoring agents, are added in order to plasticize the blend as well as to modulate the hardness, viscoelasticity and the formability of the base. Mixing is continued until a uniform mixture is obtained. Thereafter, the mixture is cooled, pressed and cut and may be formed into desirable chewing gum shapes.

This type of process involves a treatment at high temperatures which has the drawback of being the cause of degradation of heat sensitive ingredients present in the composition including active agents and flavours. Moreover, these methods require for their carrying out a particular and expensive equipment.

Alternative processes for the preparation of chewing gums and more particularly for the treatment or handling of a gum base raw material have been suggested in the prior art, in particular in U.S. Pat. No. 5,866,179 or yet in U.S. Pat. No. 5,711,961. These patents disclose processes for the preparation of chewing gums comprising as a first step the cooling of a gum base raw material, followed by its grinding, prior to incorporating other ingredients. For instance, U.S. Pat. No. 5,711,961 describes a method for preparing a tablet comprising the steps of freezing a gum base raw material to a temperature of between −20 and −25° C., and then grinding said frozen gum in order to make it suitable to be admixed with other chewing gum ingredients. In such processes, the cooling step, essential to transform the raw material in a suitable form to be further processed, is a costly and time consuming treatment.

Moreover, in all the processes disclosed in the prior art, the gum base raw material, even after a heating or a cooling treatment, is still in a form which is not suitable for the preparation of a chewing gum. In other words, the gum base raw material thus treated is not yet in a compressible form. Consequently, adjuvants have to be added during the chewing gum preparation to make the formulation compressible.

Therefore, in view of the disadvantages presented by the processes available until now, improvements, in particular a way to avoid the heating or cooling treatments of a gum base raw material and/or a way to provide a material which would be directly compressible, would be of high importance for the industry.

More recently, WO 02/069729 has described a process for making a “particulate blend gum base”. The process consists in providing a dry blend of gum base ingredients including elastomers, plasticizers, resins, fats and oils, waxes, softeners and inorganic fillers, by grinding, extruding and grinding and/or spray congealing these ingredients, and then blending them to form the particulate gum base. The choice of the method carried out to prepare a powder form of the gum base ingredients, depends on the softening points of the treated ingredients. For instance mixtruding is carried out typically with an elastomer plasticizer and a hard elastomer. These methods thus consist in treating the ingredients constituting a gum base raw material to provide a powdered gum base material ready to be used and tableted. However, the way to proceed disclosed in this document requires a lot of equipments. In fact, a variety of methods has to be possibly carried out, the choice of a particular one depending on the nature of the gum base ingredients. It could thus be useful to have a simpler method of providing a powder form of gum base ingredients suitable for any kind of ingredients.

Now, we have been able to provide a very simple method, suitable whatever the nature (in particular softening point) of the gum base ingredients, and which allows to prepare a gum base composition which is advantageously directly compressible. The process is both fast and inexpensive and avoids any particular external heating or cooling steps.

### SUMMARY OF THE INVENTION

Therefore, a first object of the present invention is a process for transforming an uncompressible gum base raw material into a compressible powdered gum base composition comprising, in weight percent, up to 85% of a synthetic and/or natural uncompressible gum base raw material, from 1 to 16% of a silicate derivative and from 4 to 30% of a polyol. The process of the invention comprises the steps of mixing the synthetic and/or natural uncompressible gum base raw material with the powdered silicate derivative and the polyol at a temperature comprised between 15 and 30° C.; letting the warm agglomerate cool down to room temperature to obtain a hard agglomerated mixture; and finally grinding the hard agglomerated mixture to obtain a compressible powder. In a particular embodiment, the powder obtained is further subjected to a sieving.

### DETAILED DESCRIPTION OF THE PREFERRED EMBODIMENTS

The term “gum base composition” as used in the present invention, is not to be understood as designating, as it is the case most of the time in the prior art, the gum base raw material, described above as a hard, and not easy to handle material. Conversely it is used to designate the final product obtained at the end of the process, namely a ready-to-be-compressed powdered composition.

The starting material used in the process of the invention, herein referred to as “gum base raw material” or as “synthetic and/or natural gum material”, is a hard, uncompressible material usually commercially available. The process herein described consists in transforming the latter raw material into the compressible gum base composition of the invention. Therefore, contrary to what is disclosed in WO 02/069729, the process of the present invention uses as starting product said commercially available gum base raw material, which consists of a mixture of elastomers, fillers, plasticizers etc. but which is in a form which is not suitable to handle. Thus, the process does not consist in treating the ingredients constituting the gum base raw material, but in transforming directly an uncompressible gum base raw material into a compressible gum base composition, ready to be tableted in a chewing gum.

The gum base composition prepared by the process according to the present invention presents first of all the advantage of being directly compressible. It is of common knowledge in this field that in the normal course of developing formulations for chewing gums, and the routine production of tablets, processing problems occur. Capping, lamination, picking and sticking, poor compressibility and flowability are the most common processing problems. In order to improve compression of the formulations, ingredients used to facilitate compression are usually added at different stages of the preparation of a chewing gum, together with other formulation ingredients.

Conversely, the product provided by the present invention is directly compressible, i.e. that it is provided in the form of a fine powder, which can thus be dry blended with other ingredients required in the final product formulation, also in a powder form, such as flavours, sweeteners or pharmaceutically active ingredients. The blend there-obtained can be simply and easily compressed to provide chewing gum tablets, without requiring any costly or complicated process and equipment. Therefore, the directly compressible powder of the invention allows the preparation of chewing tablets while avoiding any step such as heating that could be responsible for the degradation of the ingredients present in the formulation.

More objects, aspects and advantages of the invention will become apparent from the detailed description hereafter.

The synthetic and/or natural gum material or gum base raw material employed as starting product for the process of the invention, is a usually commercially available uncompressible raw material, typically containing polymers, polymer solvents, fats and oils, waxes, softeners and inorganic fillers. Examples of polymers used in this kind of product include for instance, butyl elastomers, polyisobutylene, isobutylene-isoprene copolymer and styrene butadiene rubber elastomer. Polymer solvents include terpene resins, ester gums or yet resin esters. Waxes such as paraffin, microcrystalline and natural waxes such as beeswax, candelilla, carnauba and polyethylene wax may be used. The fats and oils suitable within the framework of the preparation of such raw materials include for instance tallow, soybean or cottonseed oils, hydrogenated and partially hydrogenated vegetable oils. Usable softeners include glycerol monostearate, lecithin, or mono-, di- and triglycerol esters of fatty acids. Finally, the inorganic fillers present in a gum base raw material include for instance talc, dicalcium phosphate, calcium carbonate, magnesium carbonate and other well-known in the art.

Many synthetic and/or natural gum materials which may be used within the framework of the invention are commercially available products on sale under, in particular, the tradenames Sierra®, Nevada®, Apolo®-T, Balear®-T, Fantasy® T, Marfil® and Mallorca®, (origin: Cafosa, Spain).

Many types of gum base raw materials suit the purpose of the invention. The choice of a particular material will vary greatly, depending upon various factors such as the type of base desired (chewing gum or bubble gum), the consistency of gum desired and the other components used in the composition to make the final chewing gum product.

The gum base raw material is present within the gum base composition of the invention in an amount rising up to 85%, and is preferably present in an amount ranging between 40 and 70% by weight, relative to the total weight of the composition. The presence of a high load of gum base raw material in the composition is an unexpected and advantageous characteristic of the invention. In fact, most of the gum base compositions known up to date contain much less gum base raw material. Now, given that during consumption, namely when the product is chewed, most of the components present in the chewing gum formulation quickly dissolve and are thus released from the product and swallowed by the consumer, the gum base raw material is, in the end, the only ingredient which remains in the mouth of the consumer. Ideally, this chewable part should thus constitute a relatively important amount of matter, so that the product keeps elasticity, mastication texture and cohesiveness during consumption. This requirement has besides to be balanced with the need to provide a product of reasonable size. In fact, the less gum base raw material is present in the gum base composition, the more quantity of gum base composition is needed for the preparation of a chewing gum and therefore the bigger will be the final product, in order to satisfy the consumer demand in terms of amount of matter to chew after all the other compounds have dissolved. Therefore, it can be easily understood that a gum base composition containing a high load of gum base raw material allows to produce a final end product of reasonable size, satisfying at the same time the requirement here-above described. In other words, a gum base composition comprising a high percentage of gum base raw material (here-above designated as natural and/or synthetic gum material) allows to prepare a chewing gum of reasonable size, while providing to the consumer sufficient matter to chew, even after the other ingredients of the formulation have dissolved.

Apart from the gum base raw material, the powdered gum base composition according to the invention further comprises from 1 to 16% by weight relative to the total weight of the composition of a silicate derivative, and from 4 to 30% of a polyol.

In a particular embodiment, the silicate derivative is present in the composition in an amount comprised between 2 and 14% by weight relative to the total weight of the composition. Non limiting examples of silicate derivatives suitable for the purpose of the invention include silicon dioxide, magnesium silicate, aluminium silicate and sodium silicate. In one particular embodiment, one will use silicon dioxide, commercialised under the name Syloid® by W.R. Grace and Company, Davison Chemical Division.

In another embodiment, the powdered composition of the invention comprises from 6 to 25% by weight relative to the total weight of the composition of a polyol. Suitable polyols include but are not limited to sorbitol, mannitol, xylitol, maltitol and mixtures thereof.

In a particular way of carrying out the invention, one will use sorbitol.

Apart from the three essential ingredients mentioned above, the gum base composition of the invention may comprise additional, optional ingredients such as, for instance, colorants, pigments or yet sweeteners.

The main object of the invention is provided by a novel process for the transformation of an uncompressible gum base raw material into a compressible powdered gum base composition as defined above. The process of the invention comprises the steps of mixing an uncompressible synthetic and/or natural gum material with a powdered silicate derivative and a solid polyol at ambient temperature, to provide a warm agglomerated paste; letting the warm agglomerate cool down to room temperature to obtain a hard agglomerated mixture; and grinding the hard agglomerated mixture to provide a compressible powder.

The powdered silicate derivative is characterised by an average particle size, typically below 50 μm.

The process according to the present invention is very simple and cheap, and allows to provide a product in the form of a fine powder which presents the advantage of being directly compressible. Contrary to the processes disclosed in the prior art, the process of the present invention does not make use of external energy through a heating or a cooling treatment of the synthetic and/or natural, hard starting gum material. On the other hand, it does not require the equipment needed when the elastomers, fillers and plasticizers are initially put into a particulate form as described in WO 02/069729. The starting material is in the present case a synthetic or natural uncompressible gum material of composition chosen as a function of the desired application, which is simply introduced in a mixer such as, for instance, a twin blade mixer, together with a silicate derivative and a polyol, both in a powder form. The mixing is carried out at ambient temperature, i.e. a temperature typically comprised between 15 and 30° C. While no heating or cooling is provided, the shear force consequent to the mixing warms the mixture up to a temperature typically varying around 50° C. The resulting product of this first step of the process is in the form of a warm agglomerated paste which has lost the elastic physical property typical of the gum base raw material, and which is now in a plastic physical state. The obtained warm agglomerated paste is, in the second step of the process, simply left at ambient air, in order to cool it down to room temperature. Alternatively, the agglomerated paste may be cooled down by any other means, such as by means of a freezer. Once cooled down, the hard agglomerates have simply to be grinded in order to provide a fine powder. The grinding step can be carried out using any kind of apparatus well known in the art. Following the grinding step, the powder is subjected to a homogenisation step by means, for instance, of a mill. The obtained product presents the advantage of being homogeneous and in the form of a compressible powder with a particle size usually comprised between 50 and 500 μm.

The homogeneous powdered gum base composition obtained from the process above-described may be advantageously used for the preparation of a chewing gum.

A chewing gum comprising approximately from 15 to 80% by weight of gum base composition according to the invention, and from about 20 to about 85% by weight of a composition of additives for chewing gum is another object of the invention. What is meant here by a “composition of additives for chewing gum” is typically a composition comprising sweeteners and flavouring ingredients used to improve, enhance or modify the organoleptic properties of the final product, as well as other optional ingredients such as fillers, colouring agents, etc. Sweetening agents may be selected from a wide range of materials including water-soluble agents, water-soluble artificial sweeteners and dipeptide-based sweeteners, also including mixtures thereof. As regards the flavouring ingredients, both synthetic and natural flavouring agents derived from plants, leaves, flowers, fruits etc. and combinations thereof are useful. Specific examples of such flavouring components may be found in the current literature, e.g. in Perfume and Flavour Chemicals by S. Arctander, Montclair N.J. (USA); Fenaroli's Handbook of Flavour Ingredients, CRC Press or synthetic Food Adjuncts by M. B. Jacobs, van Nostrand Co. Inc. Such ingredients are well known to the person skilled in the art of flavouring and/or aromatising consumer products, i.e. of imparting an odour or taste to a consumer product.

In a particularly advantageous embodiment of the invention, the flavouring ingredients used in the preparation of a chewing gum according to the invention are in a solid or microencapsulated form. In fact, as the starting gum base composition is in a powder form, it may be easily blended with another powder and then compressed to provide chewing gum tablets. Therefore, flavouring ingredients or compositions employed to impart a taste to chewing gums can be used within the framework of the invention, in the form of spray-dried solids, or in other powder forms, i.e. in encapsulated forms. Flavouring ingredients in an encapsulated form are advantageously protected from degradation processes such as oxidation. Moreover, a flavouring ingredient in an encapsulated form presents the advantage of providing a controlled release of the active ingredient there-encapsulated, which is a key issue in a product such as a chewing gum.

A process for the preparation of a chewing gum, starting from the gum base composition here-above described, is also an object of the present invention. Such a process comprises, in particular, the steps of dry blending a powdered gum base composition according to the invention, together with other powdered ingredients such as flavouring ingredients or compositions, or sweeteners, and compressing the obtained mixture. The compression step may be carried out by means of any compression equipment, typically used in the industry, a more detailed description not being required here, the skilled person being capable of choosing the right equipment and adapting it as a function of his needs. The chewing gum obtained by such a process advantageously possesses a homogeneous composition, which proved to be advantageous as regards the release of active ingredients such as flavours.

As mentioned above, the powdered gum base composition of the invention particularly suits the preparation of chewing gum wherein the flavour is in the form of a powder (prepared by spray-drying, extrusion or other encapsulation method), as the latter may be simply dry blended with the starting gum composition before being compressed. The fact to prepare chewing gums starting from dry blended powders presents the advantage of avoiding any contamination of the equipment used in the mixing process, which contamination occurs when liquid flavour are used. Besides, the powdered ingredients used in the process for the preparation of chewing gums according to the invention such as flavour ingredients or compositions or yet sweeteners, will advantageously not be subjected to any processing such as heating, which could be responsible for the degradation or for a precocious release of the encapsulated ingredient.

### EXAMPLES

The invention will now be described in a more detailed manner in the following examples which are further illustrative of the present invention embodiments, and further demonstrate the advantages of the invention devices relative to prior art teachings. The temperatures are given in degrees Celsius and the abbreviations have the usual meaning in the art.

### Example 1

Preparation of a Powdered Gum Base Composition at 40% Gum Base Raw Material Load

The gum base composition was prepared from the following formulation:

| Ingredients | Grams | Parts by weight |
|---|---|---|
| Balear ® -T gum¹⁾ | 102 | 40 |
| Sorbitol | 64 | 25 |
| Syloid ® 244²⁾ | 5 | 2 |
| Icing sugar | 84 | 33 |
| Total | 255 | 100 |

¹⁾origin: Cafosa, Spain
²⁾origin: W.R. Grace Company; Davison Chemical Division.

The sorbitol, Syloid® 244 and icing sugar were premixed in a Turbula blender. The Balear®-T gum was put in a Winkworth sigma-blade mixer set at 30° C. The gum was sheared until a temperature of 50-55° was reached. The premixed powder was added and mixed with the gum base raw material until a homogeneous system was obtained in the form of a stringy paste, after approximately 5 min. The agglomerated mix was removed from the sigma-blade mixer and let to cool down to room temperature. Once the equilibrium was reached, the coarse particles were milled in a hammer mill and the resulting powder was sieved through a 1 mm sieve.

### Example 2

Preparation of a Powdered Gum Base Composition at 80% Gum Base Raw Material Load

The gum base composition was prepared from the following formulation:

| Ingredients | Grams | Parts by weight |
|---|---|---|
| Mallorca ® gum¹⁾ | 102 | 80.4 |
| Sorbitol | 15 | 5.9 |
| Syloid ® 244²⁾ | 35 | 13.7 |
| Total | 152 | 100.0 |

¹⁾origin: Cafosa, Spain
²⁾see Example 1

The powdered gum base composition was prepared similarly to what is described in Example 1.

### Example 3

Chewing Gum Prepared with a Powdered Gum Base Composition of the Invention

A chewing gum was prepared from the following formulation:

| Ingredients | Parts by weight |
|---|---|
| Gum base composition¹⁾ | 96.4 |
| Magnesium stearate | 2.0 |
| Lemon Durarome ® 501282 TDI 1091²⁾ | 0.6 |
| Lemon spray-dried 501051 TP 0551²⁾ | 0.6 |
| Citric acid | 0.4 |
| Total | 100.0 |

¹⁾composition and preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 4

Chewing Gum Prepared with a Powdered Gum Base Composition of the Invention

A chewing gum was prepared from the following formulation:

| Ingredients | Parts by weight |
|---|---|
| Gum base composition¹⁾ | 96.8 |
| Magnesium stearate | 2.0 |
| Mixture Aspartame ®/Acesulfam ® K (2/1) | 0.4 |
| Caramel Durarome ® 501403 TD 1090²⁾ | 0.2 |
| Strawberry spray-dried 501094 AP 0551²⁾ | 0.6 |
| Total | 100.0 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 5

Chewing Gum Prepared with a Powdered Gum Base Composition of the Invention

A chewing gum was prepared from the following formulation:

| Ingredients | Parts by weight |
|---|---|
| Gum base composition¹⁾ | 95.85 |
| Magnesium stearate | 2.00 |
| Mixture Aspartame ®/Acesulfam ® K (2/1) | 0.40 |
| Strawberry Flexarome ® 880138 FBS5004²⁾ | 1.00 |
| Citric acid | 0.75 |
| Total | 100.00 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 6

Chewing Gum Prepared with a Powdered Gum Base Composition of the Invention

A chewing gum was prepared from the following formulation:

| Ingredients | Parts by weight |
|---|---|
| Gum base composition¹⁾ | 95.60 |
| Magnesium stearate | 2.00 |
| Mixture Aspartame ®/Acesulfam ® K (2/1) | 0.40 |
| Strawberry Flexarome ® 880138 FBS5004²⁾ | 1.00 |
| CoolBoost ® Flexarome ® 880173 FBS0504²⁾ | 0.25 |
| Citric acid | 0.75 |
| Total | 100.00 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 7

Chewing Gum Prepared with a Powdered Gum Base Composition of the Invention

A chewing gum was prepared from the following formulation:

| Ingredients | Parts by weight |
|---|---|
| Gum base composition¹⁾ | 97.00 |
| Magnesium stearate | 2.00 |
| Mixture Aspartame ®/Acesulfam ® K (2/1) | 0.40 |
| Peppermint Flexarome ® 880085 TFS1104²⁾ | 1.00 |
| Total | 100.00 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 8

Chewing Gum Prepared with a Powdered Gum Base Composition of the Invention

A chewing gum was prepared from the following formulation:

| Ingredients | Parts by weight |
|---|---|
| Gum base composition¹⁾ | 95.60 |
| Magnesium stearate | 2.00 |
| Mixture Aspartame ®/Acesulfam ® K (2/1) | 0.40 |
| Peppermint Flexarome ® 880085 TFS1104²⁾ | 1.00 |
| FreshBoost ® Flexarome ® 880101 FBS0704²⁾ | 1.00 |
| Total | 100.00 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 9

Chewing Gum Prepared with a Powdered Gum Base Composition of the Invention

A chewing gum was prepared from the following formulation:

| Ingredients | Parts by weight |
|---|---|
| Gum base composition¹⁾ | 95.60 |
| Magnesium stearate | 2.00 |
| Mixture Aspartame ®/Acesulfam ® K (2/1) | 0.40 |
| Peppermint Flexarome ® 880085 TFS1104²⁾ | 1.00 |
| CoolBoost ® Flexarome ® 880173 FBS0504²⁾ | 1.00 |
| Total | 100.00 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

### Example 10

Chewing Gum Prepared with a Powdered Gum Base Composition of the Invention

A chewing gum was prepared from the following formulation:

| Ingredients | Parts by weight |
|---|---|
| Gum base composition¹⁾ | 95.60 |
| Magnesium stearate | 2.00 |
| Mixture Aspartame ®/Acesulfam ® K (2/1) | 0.40 |
| Peppermint Flexarome ® 880085 TFS1104²⁾ | 1.00 |
| CoolBoost ® Flexarome ® 880170 FBS0604²⁾ | 1.00 |
| Total | 100.00 |

¹⁾composition, see Example 2; preparation, see Example 1
²⁾encapsulated flavours; origin: Firmenich SA, Geneva, Switzerland

The powder gum base composition was dry blended with the other powder ingredients. The blend thus obtained was compressed by means of a manual press (Specac® machine) under a compression force of between 1 and 4 tons. Tablets of 20 mm diameter were obtained.

1. A process for transforming an uncompressible gum base raw material into a compressible powdered gum base composition comprising the steps of
a) mixing from 1 to 85% by weight of a synthetic and/or natural uncompressible gum material with from 1 to 16% by weight of a powdered silicate derivative and from 4 to 30% by weight of a solid polyol, all percentages being given by weight relative to the total weight of the mixture, at a temperature comprised between 15 and 30° C. to provide a warm agglomerated paste;
b) allowing the warm agglomerate to cool down to room temperature to obtain a hard agglomerated mixture; and
c) grinding the hard agglomerated mixture to obtain a compressible powder.

2. A process according to claim 1, wherein the powder obtained in step c) is further subjected to sieving.

3. A process according to claim 1, wherein step a) is carried out in a twin blade mixer.

4. A compressible powdered gum base composition obtainable by a process according to claim 1.

5. A gum base composition according to claim 4, comprising in weight percent, from 40 to 70% of synthetic or natural gum material.

6. A gum base composition according to claim 4, comprising in weight percent, from 2 to 14% of silicate derivative and from 6 to 25% of polyol.

7. A gum base composition according to claim 4, wherein the silicate derivative is selected from the group consisting of silicon dioxide, magnesium silicate, aluminium silicate and sodium silicate.

8. A gum base composition according to claim 7, wherein the silicate derivative consists of silicon dioxide.

9. A gum base composition according to claim 4, wherein the polyol is selected from the group consisting of sorbitol, mannitol, xylitol, maltitol and mixtures thereof.

10. A gum base composition according to claim 9, wherein the polyol consists of sorbitol.

11. A method for preparing a chewing gum product which comprises incorporating an amount of the gum base composition according to claim 4 into the chewing gum product wherein the amount is sufficient to impart a chewy consistency to the product.

12. A chewing gum comprising from 15 to 80% by weight of a gum base composition according to claim 4.

13. A process for the preparation of a chewing gum product comprising the steps of
a) dry blending a powdered gum composition as defined in claim 4 with a powdered composition comprising flavouring and sweeteners; and
b) compressing the dry blend obtained under a) to form the product.
